(19) United States
(12) Patent Application Publication
(10) Pub. No.: US 2018/0108338 A1
(43) Pub. Date: Apr. 19, 2018

(54) ACOUSTIC TRANSDUCER DEVICE COMPRISING A PIEZO SOUND TRANSDUCER AND AN MUT SOUND TRANSDUCER, METHOD OF OPERATING SAME, ACOUSTIC SYSTEM, ACOUSTIC COUPLING STRUCTURE, AND METHOD OF PRODUCING AN ACOUSTIC COUPLING STRUCTURE

(71) Applicant: Fraunhofer-Gesellschaft zur Foerderung der angewandten Forschung e.V., Munich (DE)

(72) Inventors: Markus KLEMM, Dresden (DE); Anartz UNAMUNO, Dresden (DE)

(21) Appl. No.: 15/821,081

(22) Filed: Nov. 22, 2017

Related U.S. Application Data
(63) Continuation of application No. PCT/EP2016/061296, filed on May 19, 2016.

(30) Foreign Application Priority Data
May 22, 2015 (DE) 10 2015 209 485.5

(51) Int. Cl. G10K 9/122; H04R 1/28; H04R 17/10; B06B 1/06

(52) U.S. Cl. CPC G10K 9/122; B06B 1/0622; H04R 17/10; H04R 1/2873

(57) ABSTRACT

An acoustic transducer device includes a piezo sound transducer configured to emit, on the basis of a control signal, a first sound wave in a radiation direction. The acoustic transducer device includes an MUT sound transducer configured to provide an output signal on the basis of a second sound wave received from a receive direction.

### CROSS-REFERENCE TO RELATED APPLICATIONS

This application is a continuation of copending International Application No. PCT/EP2016/061296, filed May 19, 2016, which is incorporated herein by reference in its entirety, and additionally claims priority from German Application No. DE 10 2015 209 485.5, filed May 22, 2015, which is incorporated herein by reference in its entirety.

The present invention relates to an acoustic transducer device as may be employed, e.g., for acoustically imaging methods, to a method of operating the acoustic transducer device, to an acoustic system, to an acoustic coupling structure, and to a method of producing an acoustic coupling structure. The present invention further relates to ultrasonic transducers made of piezo sound transducers and micromachined ultrasonic transducers.

### BACKGROUND OF THE INVENTION

Conventional ultrasonic transducers based on a piezo material or piezo composite (referred to as piezo below) exhibit a very high acoustic impedance. Consequently, they are able to generate high sound pressures, however they exhibit disadvantages in terms of receiving sensitivity. In addition, it is possible only with difficulty or not at all to design said transducers as array transducers at high frequencies, e.g. at frequencies higher than 30 MHz, as is described in [1], for example. For acoustically imaging high-resolution methods, however, this is of paramount importance.

In addition, bendable PVDF-based ultrasonic transducers or ultrasonic transducer foils (PVDF=polyvinylidene fluoride) which have lower acoustic impedance are known from [2]. They represent a challenge as an array element in terms of durability and electrical contacting and exhibit low sound transmitting power.

Micromachined ultrasonic transducers (MUTs) may be efficiently integrated as an array and exhibit low acoustic impedance. This is the reason why they have deficits as sound transmitters, but have very high sensitivities as sound receivers.

So far, the same type of transducer has been employed for transmitting and receiving sound in the ultrasonic range (among other things, for acoustically imagining methods). For high frequencies, e.g. in ultrasonic microscopy, one-element ultrasonic transducers are known which are mechanically panned so as to generate an image.

What would be desirable, therefore, is a concept for an efficient acoustic transducer device.

### SUMMARY

According to an embodiment, an acoustic transducer device may have: a piezo sound transducer configured to emit a first sound wave in a radiation direction on the basis of a control signal; and an MUT sound transducer configured to provide an output signal on the basis of a second sound wave received from a receive direction; wherein the piezo sound transducer and the MUT sound transducer are arranged such that the MUT sound transducer encloses the piezo sound transducer when a location of the piezo sound transducer and a location of the MUT sound transducer are projected into a plane; and wherein an internal dimension of the MUT sound transducer is larger than an external dimension of the piezo sound transducer.

According to another embodiment, an acoustic transducer device may have: a piezo sound transducer configured to emit a first sound wave in a radiation direction on the basis of a control signal; and an MUT sound transducer configured to provide an output signal on the basis of a second sound wave received from a receive direction; and an acoustic coupling element configured to acoustically couple the piezo sound transducer and the MUT sound transducer; wherein the acoustic coupling element is an acoustic lens configured to influence propagation of the first sound wave, the MUT sound transducer being mechanically connected to the acoustic lens, so that the first sound wave emitted by the piezo sound transducer and influenced by the acoustic lens impinges on the MUT sound transducer and is coupled into a medium by the MUT sound transducer; wherein the piezo sound transducer and the MUT sound transducer are arranged such that the piezo sound transducer encloses the MUT sound transducer.

According to another embodiment, an acoustic transducer device may have: a piezo sound transducer configured to emit a first sound wave in a radiation direction on the basis of a control signal; and an MUT sound transducer configured to provide an output signal on the basis of a second sound wave received from a receive direction; wherein the piezo sound transducer and the MUT sound transducer are acoustically coupled to each other, so that moving of an element of the piezo sound transducer may cause a movement in an element of the MUT sound transducer, and vice versa, so that by performing a movement on the part of the piezo sound transducer, said movement is transferred to the MUT sound transducer, and a movable element thereof is excited to move, oscillate or vibrate, so that the MUT sound transducer is directly excited by emission of the first sound wave on the part of the piezo sound transducer.

According to another embodiment, an acoustic transducer device may have: a piezo sound transducer configured to emit a first sound wave in a radiation direction on the basis of a control signal; and an MUT sound transducer configured to provide an output signal on the basis of a second sound wave received from a receive direction; wherein an internal dimension of the piezo sound transducer is larger than or equal to an external dimension of the MUT sound transducer; and an acoustic coupling element configured to acoustically couple the piezo sound transducer and the MUT sound transducer.

According to another embodiment, an acoustic system may have: an inventive acoustic transducer device; a control device configured to control the piezo sound transducer of the transducer device so as to obtain the output signal from the MUT sound transducer and so as to provide an information signal including information which relates to obtaining the second sound wave on the basis of a reflection of the first sound wave at an object.

According to another embodiment, an acoustic system may have: an acoustic transducer device which may have: a piezo sound transducer configured to emit a first sound wave in a radiation direction on the basis of a control signal; and an MUT sound transducer configured to provide an output signal on the basis of a second sound wave received from a receive direction; wherein the piezo sound transducer and the MUT sound transducer are arranged such that the MUT sound transducer encloses the piezo sound transducer when a location of the piezo sound transducer and a location of the MUT sound transducer are projected into a plane; a control device configured to control the piezo sound transducer of the transducer device so as to obtain the output signal from the MUT sound transducer and so as to provide an information signal including information which relates to obtaining the second sound wave on the basis of a reflection of the first sound wave at an object; wherein the transducer device includes a multitude of MUT sound transducer elements, the information signal being based on a multitude of output signals which are based on the second sound wave, the acoustic system including a processing arrangement configured to determine, on the basis of the information signal, a direction from which the second sound wave is received by the transducer device.

According to another embodiment, an acoustic system may have: an acoustic transducer device which may have: a piezo sound transducer configured to emit a first sound wave in a radiation direction on the basis of a control signal; and an MUT sound transducer configured to provide an output signal on the basis of a second sound wave received from a receive direction; wherein the piezo sound transducer and the MUT sound transducer are arranged such that the MUT sound transducer encloses the piezo sound transducer when a location of the piezo sound transducer and a location of the MUT sound transducer are projected into a plane; a control device configured to control the piezo sound transducer of the transducer device so as to obtain the output signal from the MUT sound transducer and so as to provide an information signal including information which relates to obtaining the second sound wave on the basis of a reflection of the first sound wave at an object; wherein the piezo sound transducer and the MUT sound transducer of the transducer device are fixedly connected to each another within a stack, wherein moving of an element of the piezo sound transducer may cause a movement in at least one element of the MUT sound transducer, and wherein the control device is configured to control the piezo sound transducer such that it moves at a frequency within a tolerance range which lies within a range of smaller than or equal to ±10% of a mechanical resonant frequency of the MUT sound transducer.

According to another embodiment, an acoustic system may have: an acoustic transducer device which may have: a piezo sound transducer configured to emit a first sound wave in a radiation direction on the basis of a control signal; and an MUT sound transducer configured to provide an output signal on the basis of a second sound wave received from a receive direction; a control device configured to control the piezo sound transducer of the transducer device so as to obtain the output signal from the MUT sound transducer and so as to provide an information signal including information which relates to obtaining the second sound wave on the basis of a reflection of the first sound wave at an object; wherein the control device is configured to control the piezo sound transducer and the MUT sound transducer simultaneously during a time interval, so that the piezo sound transducer and the MUT sound transducer generate the first sound wave at the same time.

According to another embodiment, a method of operating an acoustic transducer structure including a piezo sound transducer, an MUT sound transducer, wherein an internal dimension of the MUT sound transducer is larger than an external dimension of the piezo sound transducer, may have the steps of: emitting a first sound wave in a radiation direction with a piezo sound transducer; receiving a second sound wave from a receive direction with an MUT sound transducer, wherein the piezo sound transducer and the MUT sound transducer are arranged such that the MUT sound transducer encloses the piezo sound transducer when a location of the piezo sound transducer and a location of the MUT sound transducer are projected into a plane; and providing an output signal on the basis of the received second sound wave.

According to another embodiment, a method of operating an acoustic transducer structure may have the steps of: arranging a piezo sound transducer and an MUT sound transducer such that the piezo sound transducer encloses the MUT sound transducer; providing an acoustic coupling element, so that the piezo sound transducer and the MUT sound transducer are acoustically coupled to each other; wherein the acoustic coupling element is an acoustic lens and is provided such that propagation of the first sound wave is influenced, the MUT sound transducer being mechanically connected to the acoustic lens, so that the first sound wave emitted by the piezo sound transducer and influenced by the acoustic lens impinges on the MUT sound transducer and is coupled into a medium by the MUT sound transducer; emitting a first sound wave in a radiation direction with a piezo sound transducer; receiving a second sound wave from a receive direction with an MUT sound transducer; and providing an output signal on the basis of the received second sound wave.

According to another embodiment, a method of operating an acoustic transducer structure including a piezo sound transducer, an MUT sound transducer, wherein an internal dimension of the piezo sound transducer is larger than or equal to an external dimension of the MUT sound transducer, may have the steps of: emitting a first sound wave in a radiation direction with a piezo sound transducer; receiving a second sound wave from a receive direction with an MUT sound transducer; and providing an output signal on the basis of the received second sound wave; providing an acoustic coupling element such that same is configured to acoustically couple the piezo sound transducer and the MUT sound transducer.

The core idea of the present invention consists in having recognized that functional separation of transmitting sound transducers and receiving sound transducers as well as designing said two sound transducers in a different manner enable efficient emission of sound waves and efficient reception of sound waves. The gain in efficiency obtained may be high enough for potential disadvantages which might result, e.g., from functional and spatial separation of transmitting sound transducers and receiving sound transducers will be more than compensated for.

In accordance with one embodiment, an acoustic transducer device includes a piezo sound transducer configured to emit a first sound wave in a radiation direction on the basis of a control signal. The acoustic transducer device further includes an MUT sound transducer (MUT=micromachined ultrasonic transducer) configured to provide an output signal on the basis of a second sound wave received from a receive direction. What is advantageous about this embodiment is that the first sound wave may be efficiently produced by means of the piezo sound transducer, and the second sound wave may be received with a high level of sensitivity, i.e. efficiency, by means of the MUT sound transducer. Thus, functional division enables bypassing of the previous disadvantages.

In accordance with a further embodiment, the MUT sound transducer is arranged along the radiation direction of the piezo sound transducer. What is advantageous about this embodiment is that both sound transducers may be utilized for a transmission function and/or a receiving function.

In accordance with a further embodiment, the piezo sound transducer and the MUT sound transducer are acoustically coupled to each other, so that the MUT sound transducer is directly excited by emission of the first sound wave on the part of the piezo sound transducer. What is advantageous about this embodiment is that information on the operation of the piezo sound transducer may be obtained, e.g. for calibration purposes, on the basis of the output signal.

In accordance with a further embodiment, the acoustic transducer device includes an acoustic lens configured to influence propagation of the first sound wave, the MUT sound transducer being mechanically connected to the acoustic lens, so that the first sound wave emitted by the piezo sound transducer and influenced by the acoustic lens impinges on the MUT sound transducer and is coupled into a medium by the MUT sound transducer. What is advantageous about this embodiment is that by means of the acoustic lens, acoustic beam guidance of at least the emitted first sound wave is made possible, for example in order to enable focusing or scattering of the sound wave.

In accordance with a further embodiment, the piezo sound transducer and the MUT sound transducer are fixedly connected to each another within a stack, wherein moving of an element of the piezo sound transducer or of the MUT sound transducer may cause a movement in an element of the other sound transducer. What is advantageous about this is that reciprocally interactive (e.g. amplifying or attenuating) operation of the sound transducers is enabled. As a result, any arising absolute sound pressure and/or a bandwidth of sound waves emitted by both sound transducers may be influenced.

In accordance with a further embodiment, the piezo sound transducer and the MUT sound transducer are arranged such that the piezo sound transducer encloses the MUT sound transducer or that the MUT sound transducer encloses the piezo sound transducer when a location of the piezo sound transducer and a location of the MUT sound transducer are projected into a plane. What is advantageous about this embodiment is that the architecture may be realized with simple means. In addition, points or areas where a natural focus of both sound transducers, i.e. a focus that is not influenced by any control, may be arranged on a line, so that a high level of space efficiency of the device may be achieved.

In accordance with a further embodiment, the acoustic transducer device comprises a multitude of sound transducers, i.e. at least a second piezo sound transducer or at least a second MUT sound transducer, the sound transducers being arranged to alternate in terms of their type, i.e. the plurality of piezo sound transducers are spaced apart along the path by the MUT sound transducer, or the plurality of MUT sound transducers are spaced apart along the path by the piezo sound transducer. What is advantageous about this is that the functions of transmitting or receiving may be intermingled with regard to a radiation surface or a receiving surface. What is also advantageous is that on the basis of the spacings between elements having identical functions (piezo sound transducers or MUT sound transducers), beam forming of the corresponding function may be efficiently performed.

In accordance with a further embodiment, the piezo sound transducer and/or the MUT sound transducer is formed as an array including a plurality of piezo sound transducer elements or MUT sound transducer elements. On the basis of individually controllable or readable elements, a direction may be determined from which a sound wave is received or into which a sound wave is transmitted.

In accordance with a further embodiment, the plurality of sound transducer elements of a sound transducer are fixedly connected to one another mechanically. What is advantageous about this is that a movement induced by the respectively other sound transducer, e.g. by the piezo sound transducer to the MUT sound transducer, is distributed across several elements of the array.

In accordance with a further embodiment, the receive direction and the radiation direction are trigonometrically linked via an object reflecting the sound wave. What is advantageous about this is that a place where an object is located may be determined via the trigonometric relationship and that a reciprocal functional connection may be established between the sound wave received and the sound wave transmitted.

In accordance with a further embodiment, an acoustic system includes an acoustic transducer device and a control device configured to control the piezo sound transducer of the transducer device so as to obtain the output signal from the MUT sound transducer and to provide an information signal comprising information which relates to obtaining the second sound wave on the basis of a reflection of the first sound wave at an object. What is advantageous about this is that by correlating the first sound wave with the (expected) second sound wave it is possible to detect an object reflecting the sound wave or to determine a property thereof (e.g. a size, a distance, a surface condition, or the like).

In accordance with a further embodiment, the control device is configured to control the piezo sound transducer and the MUT sound transducer simultaneously during a time interval, so that the piezo sound transducer and the MUT sound transducer generate the first sound wave at the same time. What is advantageous about this is that the first sound wave may be produced with a high level of acoustic power.

In accordance with a further embodiment, the acoustic system includes a processing arrangement configured to obtain the information signal from the control device and to generate from the information signal an image signal which may be represented as an optical image of the received sound wave and is based on a reflection of the first sound wave at an object, the second sound wave being obtained on the basis of the reflection. What is advantageous about this is that the acoustic system may be employed as a measuring head for imaging acoustic methods.

In accordance with a further embodiment, the transducer device of the acoustic system includes a multitude of MUT sound transducers, the information signal being based on a multitude of output signals which are based on the second sound wave, the acoustic system including a processing arrangement configured to determine, on the basis of the information signal, a direction from which the second sound wave is received by the transducer device. What is advantageous about this is that information about the object reflecting the sound wave, e.g. a location, may be obtained on the basis of the direction from which the second sound wave is received. This enables beam forming on the receiver-side, so that a number of mechanically movable elements, e.g. elements that may be tilted or shifted, of the transducer device is small or that an arrangement thereof may be prevented. This may result in increased mechanical robustness of the transducer device.

In accordance with a further embodiment, an acoustic system includes a display element configured to present an image signal or information based on the information signal. What is advantageous about this is that an optical image of the sound wave received or information derived from the information signal, e.g. a size or a distance of the object, for example, may be graphically presented.

In accordance with a further embodiment, the piezo sound transducer is formed as an array including a plurality of piezo sound transducer elements, the control device being configured to control the multitude of piezo sound transducer elements within a first time interval such that the first sound wave is emitted in a first direction. The control device is configured to control the multitude of piezo sound transducer elements within a second time interval such that the first sound wave is emitted in a second direction. This enables a modified emitting direction of the acoustic system; it being possible to dispense with any mechanical tilting of the transmitter. This enables increased robustness of the acoustic system.

In accordance with a further embodiment, the piezo sound transducer and the MUT sound transducer of the transducer device are fixedly connected to each another within a stack. Moving of an element of the piezo sound transducer may cause a movement in an element of the MUT sound transducer. The control device is configured to control the piezo sound transducer such that it moves at a frequency which essentially corresponds to a mechanical resonant frequency of the MUT sound transducer. This enables operation of the piezo sound transducer in resonance and/or antiresonance with the MUT sound transducer. This enables adaptation of a frequency range of the first threshold.

In accordance with a further embodiment, an acoustic coupling structure includes an acoustic lens configured to receive a received sound wave at a first side so as to influence the received sound wave in order to obtain an influenced sound wave at a second side of the acoustic lens. The acoustic coupling structure further includes a sound transducer mechanically connected to the acoustic lens at a second side of the acoustic lens, so that the sound wave influenced by the acoustic lens may be coupled, by means of the sound transducer, into a medium surrounding the acoustic coupling structure. What is advantageous about this is that the acoustic lens, i.e. the acoustic beam formation, may be adapted to the MUT sound transducer; this acoustic coupling element may be coupled or connected with different sound transducers for generating the sound wave.

Further embodiments relate to a method of operating an acoustic transducer structure and to a method of producing an acoustic coupling structure.

### BRIEF DESCRIPTION OF THE DRAWINGS

Embodiments of the present invention will be detailed subsequently referring to the appended drawings, in which:

FIG. 1 shows a schematic block diagram of an acoustic transducer device in accordance with an embodiment;

FIG. 2 shows a schematic block diagram of an acoustic transducer device comprising a modified piezo sound transducer, in accordance with an embodiment;

FIG. 3 shows a schematic block diagram of an acoustic transducer device comprising the modified piezo sound transducer and a modified MUT sound transducer, in accordance with an embodiment;

FIG. 4 shows a schematic block diagram of an acoustic transducer device comprising connections between MUT sound transducer elements, in accordance with an embodiment;

FIG. 5 shows a schematic block diagram of an acoustic transducer device comprising the piezo sound transducer and the modified MUT sound transducer, in accordance with an embodiment;

FIG. 6 a schematic view of an acoustic coupling structure in accordance with an embodiment;

FIG. 7 shows a schematic block diagram of an acoustic transducer device comprising an acoustic lens, in accordance with an embodiment;

FIG. 8a shows a schematic view of a transducer device, wherein the MUT sound transducer is formed to be two-dimensionally circular and wherein the piezo sound transducer is formed to be annular, in accordance with an embodiment;

FIG. 8b shows a schematic view of a transducer device, wherein the piezo sound transducer is configured as a polygonal chain, in accordance with an embodiment;

FIG. 8c shows a schematic view of a transducer device which is formed to be complementary or inverse to the transducer device of FIG. 8b, in accordance with an embodiment;

FIG. 8d shows a schematic perspective view of the configuration of FIG. 8a;

FIG. 9a shows a schematic view of a transducer device, wherein two piezo sound transducers are spaced apart by the MUT sound transducer, in accordance with an embodiment;

FIG. 9b shows a schematic view of a transducer device, wherein two MUT sound transducers are spaced apart by the piezo sound transducer 12, in accordance with an embodiment;

FIG. 9c shows a schematic view of a transducer device, wherein in each case two MUT sound transducers are spaced apart from each another by one piezo sound transducer, respectively, in accordance with an embodiment;

FIG. 10 shows a schematic block diagram of an acoustic system in accordance with an embodiment;

FIG. 11 shows a schematic flow chart of a method of operating an acoustic transducer structure in accordance with an embodiment; and

FIG. 12 shows a schematic flow chart of a method of producing an acoustic coupling element in accordance with an embodiment.

### DETAILED DESCRIPTION OF THE INVENTION

Before embodiments of the present invention will be explained in more detail below by means of the figures it shall be noted that elements, objects and/or structures of the various figures which are identical or identical in function or in effect are provided with identical reference numerals, so that the descriptions of said elements provided in various embodiments are mutually exchangeable and/or mutually applicable.

Embodiments described below relate to piezo sound transducers and MUT sound transducers. Piezo sound transducers may comprise one or more piezo-active materials such as a PZT material (lead (Pb) zirconate titanate), a zinc oxide material (ZnO) or the like.

Piezo sound transducers may comprise one or more components. At least one of the elements may be configured to transform a deformation, induced by external forces, of the piezo material to electric voltage while exploiting a piezo effect and/or to transform an applied electric voltage to a deformation of the piezoelectric material while exploiting an inverse piezo effect. Piezo sound transducers thus may be configured to generate, when controlled by a control signal, a sound wave which results from the deformation of the piezo materials. An incoming sound wave resulting in a deformation of the piezo materials may be tapped as an electric signal at the piezo sound transducer. Piezo sound transducers may be configured as a stack configuration or a patch configuration, for example. Patch transducers, in particular, are characterized by large shear forces which may be introduced into a structure, which enables large forces which are induced into the structure. Patch transducers and stack transducers may be formed of several components, e. g. several piezo layers of a stack or several piezo fibers or areas of a patch.

MUT sound transducers may exhibit a small constructional size and may exploit one or more physical effects. For example, so-called CMUTs (capacitive MUTs) exploit a capacitive effect, wherein movement of a plate results in a change in a coefficient of capacitance which may be sensed in an output signal. Magnetic MUTs (MMUTs) may be configured to detect a change in a magnetic field and/or a movement of a movable element within a magnetic field. MUTs exploiting the piezoelectric effect (PMUT=piezoelectric MUT) may be configured, e. g., to sense a deformation of the membrane by piezoelectrically provided charge carriers which are based on the deformation. As compared to piezo sound transducers, MUT sound transducers may exhibit a low level of rigidity of an equivalent spring mass system describing the respective transducer. This may also be interpreted to mean that, e. g., piezo sound transducers may induce large forces in structures, i. e. that high amplitudes (e. g. of sound waves) may be generated, whereas sensitivity to incoming forces is low. With MUT sound transducers, the sensitivity may be high, on the basis of a low level of rigidity, which may allow a large amount of movement of the MUT components, whereas the low level of rigidity (high level of softness) may result in lower efficiency of the application of force.

Piezo sound transducers and/or MUT sound transducers may comprise an array configuration including a plurality of piezo sound transducer elements and/or MUT sound transducer elements. This means that an MUT sound transducer or a piezo sound transducer may be formed as a composite of several or many MUT cells and/or piezo cells. An MUT sound transducer and/or a piezo sound transducer may be understood to mean that all of the sound transducer elements (cells) within the sound transducer (element) are electrically connected in parallel.

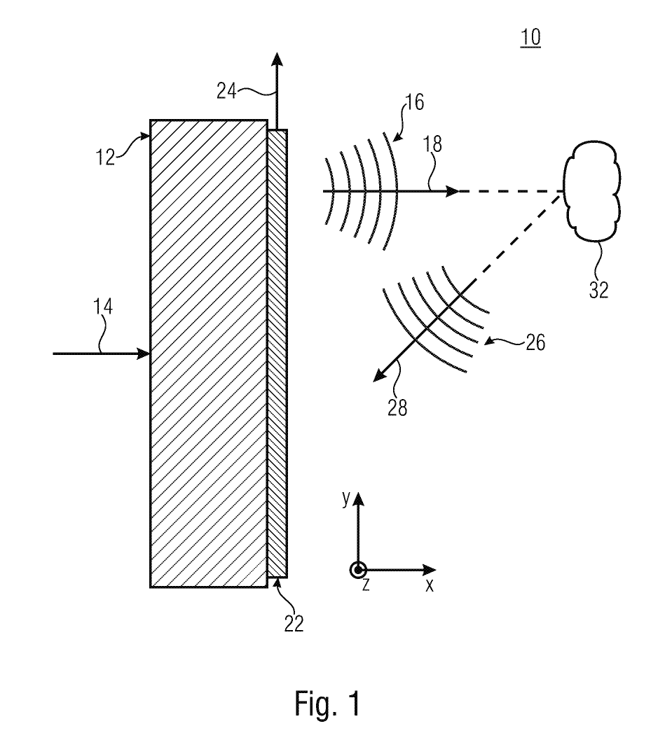

FIG. 1 shows a schematic block diagram of an acoustic transducer device 10. The acoustic transducer device 10 includes a piezo sound transducer 12 configured to emit a sound wave 16 in a radiation direction 18 on the basis of a control signal 14.

The acoustic transducer device 10 includes an MUT sound transducer 22 configured to provide an output signal 24 on the basis of a sound wave 26, said output signal 24 being received from a receive direction 28.

For example, the sound wave 26 may be based on a reflection of the sound wave 16 at an object 32. The radiation direction 18 and the receive direction 28 may be trigonometrically linked, e. g. on the basis of an orientation of a surface of the object 32 with regard to the radiation direction 18. A trigonometric link may include deflection or redirection of the sound wave 16 along one or more spatial directions, e. g. an x direction, a y direction and/or a z direction. In particular, the sound wave 16 may be deflected, influenced and/or reflected by several objects.

The device 10 may be employed, e. g., as a measuring head for an acoustic system as may be used, e. g., for an imaging acoustic method. In accordance with an advantageous implementation, one or more directional components x, y and/or z of the radiation direction 18 and of the receive direction 28 may be identical. For example, this may be understood to mean that the sound wave 16 is emitted in a direction of the device 10 and that the sound wave 26 is received from said direction, possibly with a modified scattering characteristic and/or a changed angle at which the sound wave 26 impinges on the device 10.

The MUT sound transducer 22 may be directly connected to the piezo sound transducer 12. This may be obtained, for example, by means of an adhesive or bonding method. The piezo sound transducer 12 and the MUT sound transducer 22 may form at least part of a stack within which the sound transducers 12 and 22 are fixedly connected to each another. In this context, layers may be arranged between the sound transducers 12 and 22, e. g. adhesive layers. Alternatively, the sound transducers 12 and 22 may be arranged directly at one another.

The fixed mutual connection of the sound transducers 12 and 22 may enable acoustic coupling of the sound transducers 12 and 22. For example, moving of an element of the piezo sound transducer 12 may cause a movement in an element of the MUT sound transducer 22, and vice versa. For example, if the piezo sound transducer 12 performs a movement, said movement may be transferred to the MUT sound transducer and may excite a movable element thereof (e. g. a plate) to move, oscillate or vibrate. In simple terms, the MUT sound transducer may be directly excited by emission of the sound wave by the piezo sound transducer. Alternatively or additionally, moving of the MUT sound transducer 22 may cause a movement of an element of the piezo sound transducer 12.

The acoustic transducer device 10 enables emission of the sound wave 16 with a high sound pressure power of the sound wave 16. In addition, the acoustic transducer device 10 enables efficient, i. e. precise and/or sensitive, reception of the sound wave 26.

As compared to known concepts, wherein transmit and receive transducers mostly are not only of the same type of transducer (e. g. piezo), but one and the same transducer, functional separation of a receive sound transducer (or possibly receive array) and a transmit sound transducer (possibly transmit array) may enable increased efficiency of the device. Integration as an array, i. e. arranging many individual controllable elements within the space, enables electronic focusing of the sound beam in the case of transmitting and/or receiving and, thereby, producing of an image. In addition, the functional separation enables transmit transducers and receive transducers to positively influence one another.

In known concepts, receive-side adaptations are proposed. For example, US 2010/0207489 A1 describes that MUT sound transducers are employed as filters so as to influence a signal obtained from a piezo sound transducer in the receiving case.

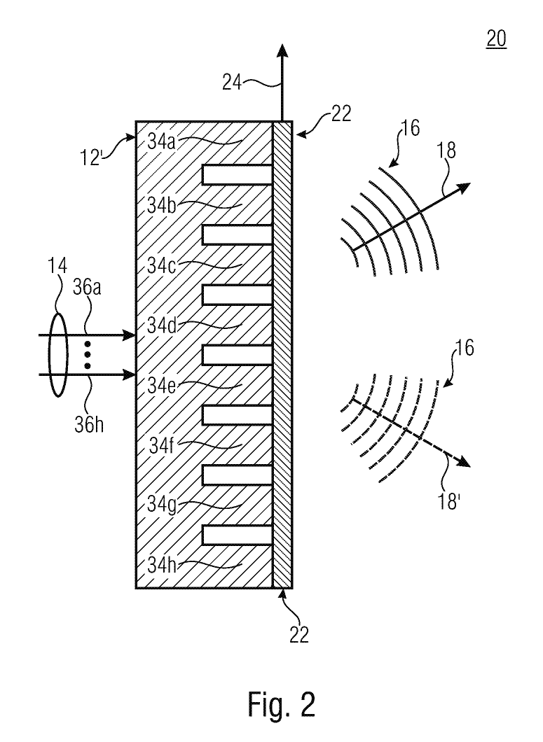

FIG. 2 shows a schematic block diagram of an acoustic transducer device 20 which comprises a piezo sound transducer 12′ modified as compared to the acoustic transducer device 10. The piezo sound transducer 12′ includes a plurality of piezo sound transducer elements 34a-h. The control signal 14 may comprise a corresponding multitude of information or partial signals 36a-h, so that the piezo sound transducer elements 34a-h may be individually controlled. Individual control may be effected such that the sound wave 16 is emitted along the radiation direction 18 during a first time interval and is emitted along a changed radiation direction 18′ during a second time interval. The first time interval and the second time interval may fully or partly overlap or may fully or partly differ from each other. For example, the sound wave 16 may also be emitted along several directions at the same time, for example in that only some of the piezo sound transducer elements 34a-h are controlled for each (partial) sound wave 16. Alternatively or additionally, the sound waves 16 may also be consecutively emitted along different directions 18 and/or 18′.

The MUT sound transducer 22 may be mechanically connected to several or all of the piezo sound transducer elements 34a-h. This enables the movements of the individual piezo sound transducer elements 34a-h (piezo array elements) to a surface of the MUT sound transducer 22 to be forwarded.

In simple terms, configuration of the piezo sound transducer 12′ as an array of piezo sound transducer elements 34a-h enables implementation of transmitter-side beam forming during transmission of the sound wave 16.

In other words, the MUT sound transducer may also be configured as an array, so that beam forming during reception of the sound wave is enabled for acoustic imaging methods.

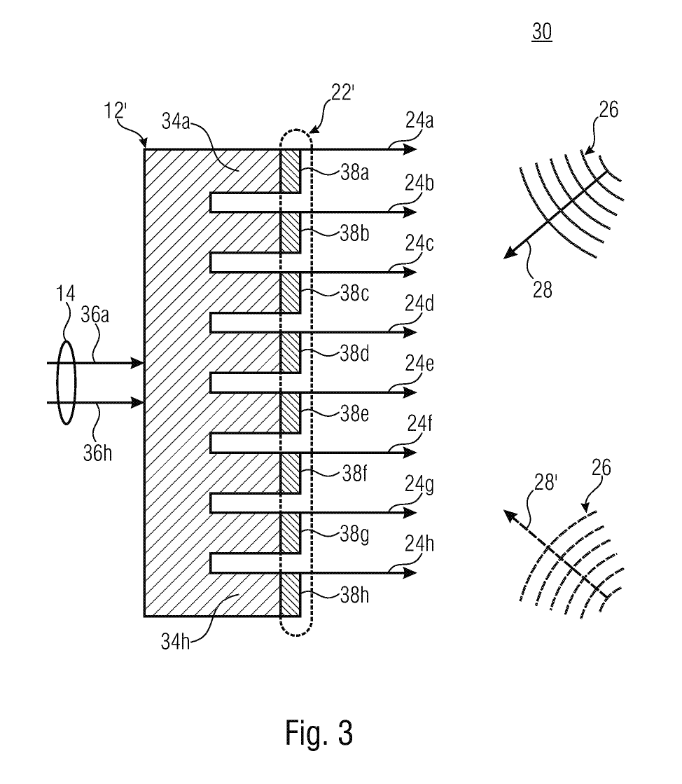

FIG. 3 shows a schematic block diagram of an acoustic transducer device 30 comprising an MUT sound transducer 22′ modified as compared to the acoustic transducer devices 10 and 20. The acoustic transducer device 30 includes the piezo sound transducer 12′. The MUT sound transducer 22′ includes a plurality of MUT sound transducer elements 38a-h configured to provide a (partial) output signal 24a-h. The sound wave 26 may be received by different MUT sound transducer elements 38a-h which are mutually offset in phase and/or have different angles, which enables evaluating of the mutually different signals 24a-h.

The MUT sound transducer 22′ may also be understood to mean that the multitude of MUT sound transducer elements 38a-h are arranged and are configured to provide an output signal 24a-h on the basis of the received sound wave 26, respectively. Evaluation of the output signals 24a-h enables receiver-side beam forming. For example, a processor may be configured to evaluate the multitude of output signals 24a-h so as to determine a direction 28 or 28′ from which the received sound wave 26 is being received or has been received.

Even though the piezo sound transducer 12′ and the MUT sound transducer 22′ have been described to include eight sound transducer elements 34a-h and 38a-h, respectively, the sound transducers 12′ and/or 22′ may also comprise a different number of elements, e. g. at least 2 and at the most 10,000, at least 100 and at the most 7,000, or at least 128 and at the most 5,000, e. g. 128, 256, 1,024 or 2,048. The number of sound transducer elements may be arbitrary, however. In particular, higher numbers may also be realized since a limiting factor may be an increasingly controllable and a decreasingly limiting complexity of electronic circuits. An increasing number of sound transducer elements may be described as an increasing number of channels. Large numbers of channels may be easier to implement with MUTs than with piezo sound transducers, in principle. The sound transducer elements may be arranged, e. g., within a one-dimensional array (1×m with m≥2 or n×1 with n≥2) or within a two-dimensional array (m×n with m≥1, n≥1 and m+n≥2). The numbers of sound transducer elements of the piezo sound transducer 12′ and of the MUT 22′ may be identical or different.

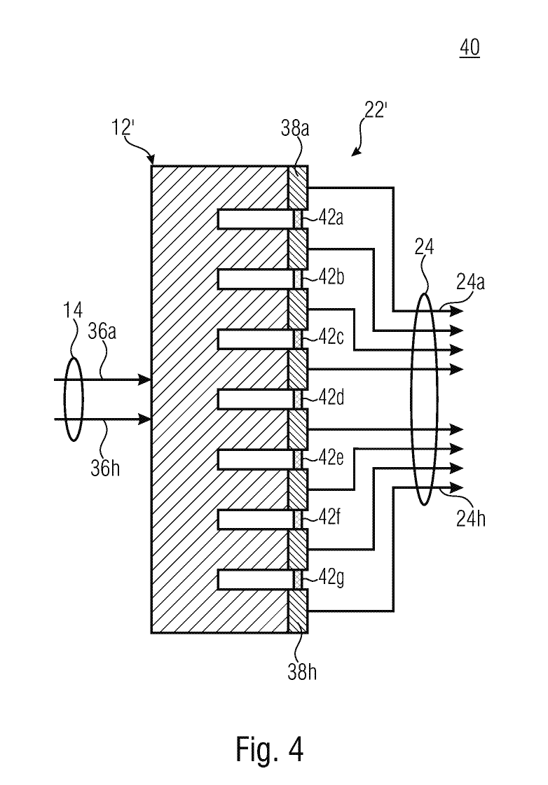

FIG. 4 shows a schematic block diagram of an acoustic transducer device 40 comprising the piezo sound transducer 12′ and the MUT sound transducer 22′. A connecting element 42a-g is arranged between two adjacent MUT sound transducer elements 38a-h, respectively, so that two MUT sound transducer elements 38a-h connected by a respective connecting element 42a-g are mechanically connected to each other.

The connecting elements 42a-h may also have a sound transducer function, for example by being configured as an MUT sound transducer or as an MUT sound transducer element.

The connecting elements may each or jointly be configured to provide an output signal. Alternatively, for example, the MUT sound transducer 22 may be modified to have a thinner configuration in an area located between the piezo sound transducer elements 34a-f.

Alternatively or additionally, the piezo sound transducer elements of the piezo sound transducer 12′ may also be mechanically connected to one another. For example, a connection between MUT sound transducer elements 38a-h by means of the connecting elements 42a-g may enable that actuation of one of the piezo sound transducer elements is transferred to several or all of the MUT sound transducer elements 38a-h in the form of a movement or vibration and that said movement or vibration is detectable by means of the output signal 24. Mutual connection of the piezo sound transducer elements may enable moving of any of the MUT sound transducer elements 38a-h to result in a movement in one or more piezo sound transducer elements, which movement may be obtained, by means of the piezo effect, as a signal to the piezo sound transducer. This may be effected, for example, at the same terminals at which the control signal 14 is supplied to the piezo sound transducer 12′.

In other words, the MUT sound transducer may be applied onto the entire piezo array. The MUT sound transducer (MUT sound transducer) may be adapted or optimized with regard to its geometry and rigidity, for example, such that the movements of the individual piezo array elements may be forwarded to the surface of the MUT.

In other words, FIG. 4 shows a piezo transducer array having an adapted MUT sound transducer.

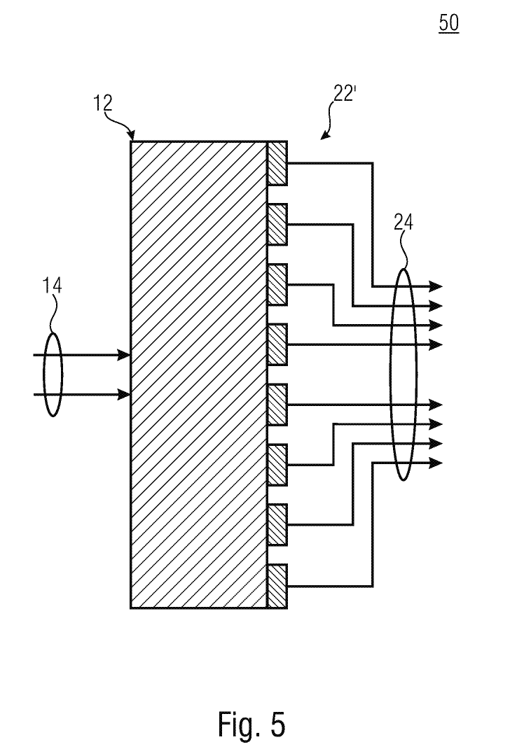

FIG. 5 shows a schematic block diagram of an acoustic transducer device 50 including the piezo sound transducer 12 and the MUT sound transducer 22′ arranged at the piezo sound transducer 12. Such an arrangement enables receiver-side beam forming, for example.

In addition to mechanical coupling between the piezo sound transducers 12 or 12′ and the MUT sound transducers 22 or 22′, the acoustic transducer devices 10, 20, 30, 40 and 50 also comprise acoustic coupling between the sound transducers. This means that also the MUT sound transducer is excited by emission of the sound wave 16.

In other words, the MUT sound transducer may be directly mounted on the piezo transducer. For transmission, the piezo sound transducer may be electrically excited to vibrate. The MUT sound transducer is arranged, e.g., to perform the same vibration as the piezo sound transducer. Thus, the piezo sound transducer may serve as an actuator for the entire MUT sound transducer. The sound may be radiated off at the front side of the MUT sound transducer.

For reception, the sound signal at the MUT sound transducer may be evaluated. The MUT sound transducer may have a higher reception sensitivity than the piezo transducer.

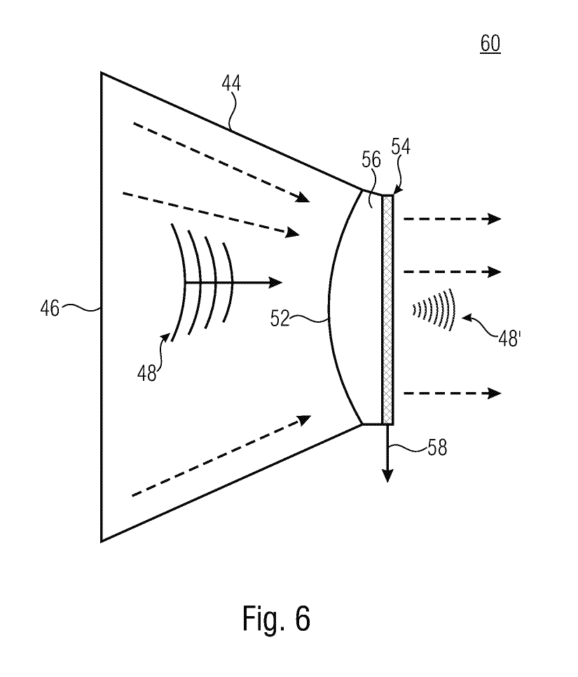

FIG. 6 shows a schematic view of an acoustic coupling structure 60 comprising an acoustic lens 44. The acoustic lens 44 has a first side 46, the acoustic lens 44 being configured to receive a sound wave 48, e.g., the sound wave 16. The optical lens 44 is configured to influence the sound wave 48. This may relate to focusing and/or scattering of the sound wave 48, for example. The acoustic lens 44 has a second side 52. The second side 52 has a concave shape, for example. Alternatively, the second side 52 may also have a different shape, for example be convex, be arched in portions or be shaped in a straight line or be configured as a straight-line side. Even though the first side 46 is depicted to be shaped in a straight line, the first side 46 may also have a different shape, e.g., a convex shape or a concave shape or a combination of straight-line and arched shapes. For example, the optical lens 52 may be configured to focus the sound wave 48 and emit it in a collimated manner, as indicated by the dashed optical paths.

A sound transducer 54, e.g., the MUT sound transducer 22 or the piezo sound transducer 12, may be arranged at the second side 52 or adjacently thereto. Alternatively or additionally, a different sound transducer, e.g., the piezo sound transducer 12′ or the MUT sound transducer 22′, may be arranged. A volume 56 may be arranged between the sound transducer 54 and the second side 52. The volume 56 may include a fluid, e.g., a liquid or a gas or a vacuum. Alternatively, the volume 56 may have solid matter arranged therein or not be provided, e.g., when the second side 52 is configured in a straight line.

The sound transducer 54 may be configured to provide an output signal 58, e.g., the output signal 24. The sound transducer 54 may be mechanically connected to the acoustic lens 44 at the second side 52, so that the sound wave 48 influenced by the acoustic lens 44 may be coupled, as an influenced sound wave 48′, into a medium, which surrounds the acoustic coupling structure 60, by means of the sound transducer 54. The surrounding medium may be a fluid, for example, e.g., a gas (air) or a liquid.

The acoustic coupling structure 60 may be coupled to a (transmit) sound transducer and be configured to influence a sound wave 48 generated by the coupled sound transducer such that the influenced sound wave 48′ is tuned to the sound transducer 54.

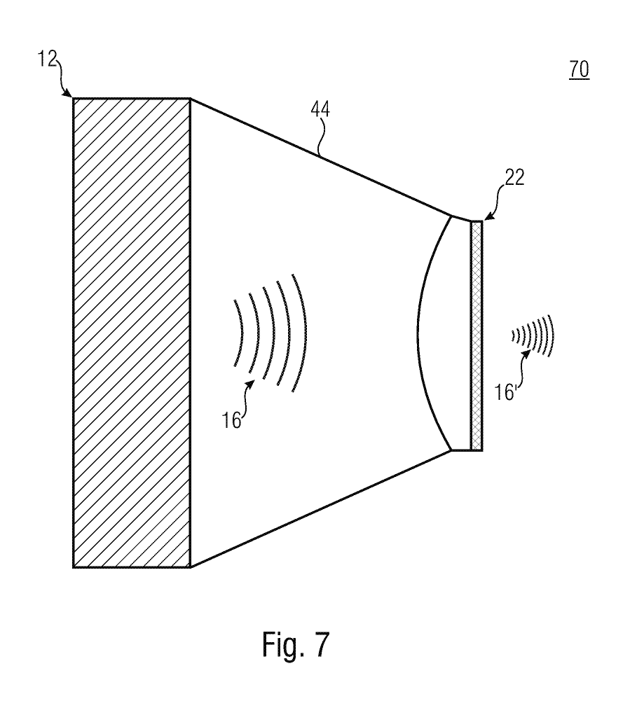

FIG. 7 shows a schematic block diagram of an acoustic transducer device 70 comprising the acoustic lens 44, which is arranged between the piezo sound transducer 12 and the MUT sound transducer 22. The acoustic lens 44 is configured to acoustically couple the piezo sound transducer and the MUT sound transducer. For this purpose, e.g., the first side of the acoustic lens 44 may be connected to the piezo sound transducer 12 in a mechanical or mechanically fixed manner.

The acoustic lens 44 is configured to influence propagation of the sound wave 16. The MUT sound transducer 22 is mechanically connected to the acoustic lens 44, as described in connection with the sound transducer 54. This enables the sound wave 16 emitted by the piezo sound transducer 12 to be influenced, so that an influenced sound wave 16′ is obtained. The influenced sound wave may impinge on the MUT sound transducer and be coupled into a medium arranged on a side of the MUT 22 sound transducer which faces away from the acoustic lens 44.

Even though the acoustic transducer device 70 is described such that the piezo sound transducer 12 and the MUT sound transducer 22 are acoustically coupled by means of the acoustic lens 44, it is also possible for a different coupling element to be arranged between the sound transducers 12 and 22, e.g., an attenuator, an acoustic channel or the like. Alternatively or additionally, the acoustic transducer device 70 may also be arranged multiple times, i.e., as an array.

In other words, FIG. 7 shows a piezo transducer having acoustic beam guidance and an adjacent MUT element as well as a connection of the MUT sound transducer and the piezo sound transducer via acoustic beam guidance. Particularly in the field of ultrasonic microscopy, “large” one-element transducers may be employed in order to be able to achieve sufficient sound pressure, among other things because integration of a piezo as an array within this frequency range of, e.g., more than 10 MHz involves a large amount of expenditure in terms of technology. The sound radiated off the piezo sound transducer may be formed and/or focused by coupling elements, e.g., intermediate layers, acoustic adaptation layers and/or acoustic lenses. In microsystems technology it is possible to produce MUT arrays also for frequency ranges of more than 30 MHz. However, on the basis of a low impedance of the MUT sound transducers this may result in that in the transmit case only small transmitting powers of the MUT sound transducers may be obtained, so that they will only emit little sound. While using the piezo sound transducer, said technical disadvantage may be partly, fully or excessively compensated for. Embodiments enable transmission of sound with a piezo sound transducer, forming of sound by means of acoustic beam guidance, and subsequent integration of an MUT sound transducer. The MUT sound transducer may be deflected from behind by the impinging sound wave (sound wave 16), and the sound may be forwarded to the test object.

In the receiving case, the MUT sound transducer may be used as a detector. The MUT sound transducer in turn may be configured as an individual element in order to increase sensitivity as compared to utilization of a piezo sound transducer. Implementation of the MUT sound transducer as an array (as an MUT sound transducer 22′) may be particularly advantageous in terms of enabling also so-called reception beam forming and, therefore, e.g., imaging evaluation methods without mechanically tilting the transducer. Moreover, a combination of beam forming and mechanical tilting may considerably increase image quality and the resolution of the imaging evaluation method.

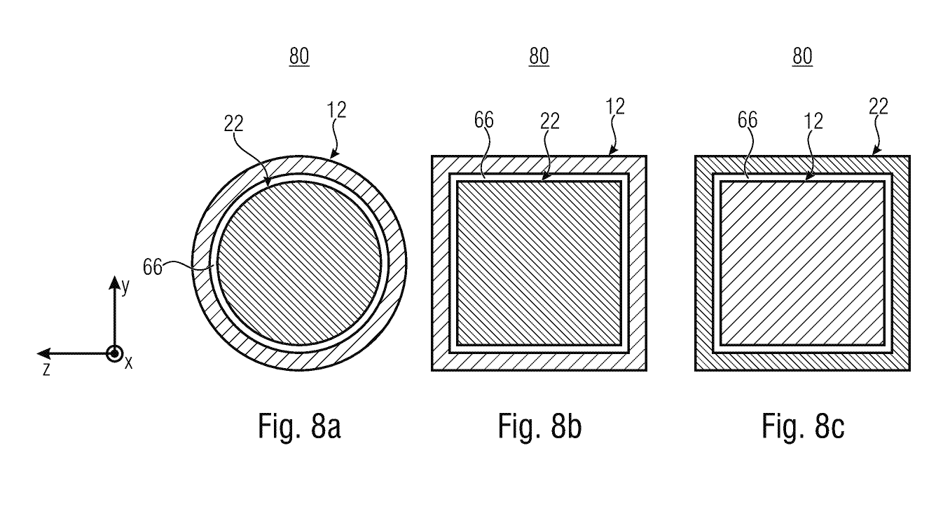

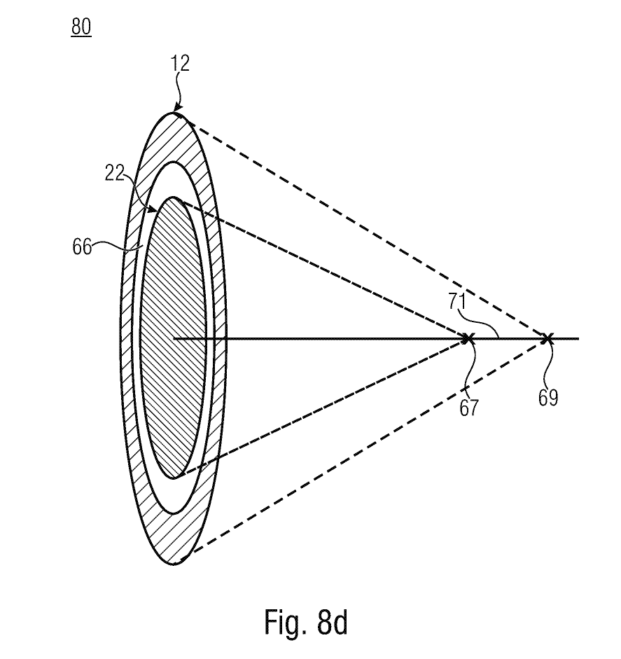

Even though the acoustic transducer devices 10, 20, 30, 40, 50 and 70 have been described such that the MUT sound transducer is arranged along a direction parallel to the radiation direction 18 of the sound wave 16, the sound transducers may also be arranged within a plane, as will be explained below by means of FIGS. 8a-c. Alternatively, the MUT sound transducer may also be arranged, on the basis of the configuration below, in a direction which is opposite the radiation direction 18.

FIGS. 8a-c show schematic views of an acoustic transducer device 80 with mutually different arrangements of the MUT sound transducer 22 with regard to the piezo sound transducer 12. As compared to a perspective depicted in FIG. 1, the perspective of FIGS. 8a-c is rotated in space by 90°, so that a direction that is parallel or antiparallel to the radiation direction 18 points in a direction of the observer.

FIG. 8a shows a schematic view of a first configuration, wherein the MUT 22 is formed to be two-dimensionally circular and wherein the piezo sound transducer 12 is formed to be annular. An inside diameter of the piezo sound transducer 12 is larger than or equal to an outside diameter of the MUT sound transducer 22. If the locations of the piezo sound transducer 12 and of the MUT sound transducer 22 are projected into a plane, e.g., a plane of observation (e.g., a x/y plane) of FIG. 8a, the piezo sound transducer 12 will be arranged to enclose the MUT 22 sound transducer. As was set forth above, the MUT sound transducer 22 may be arranged, along the x direction, in front of or behind the piezo sound transducer 12 or may have an identical position in the x direction.

A distance 66 may be arranged between the piezo sound transducer 12 and the MUT sound transducer 22, an area of the distance 66 may have elements or media arranged therein which enable acoustic and/or mechanical coupling between the transducers 12 and 22.

FIG. 8b shows a configuration of the piezo sound transducer 12 and of the MUT sound transducer 22, wherein the piezo sound transducer 12 is formed as a polygonal chain, e.g., as a track revolving in a quadrangle, a curved track (bar) or the like, said polygonal chain enclosing the MUT sound transducer 22. The MUT sound transducer 22 is shaped as a quadrangle, or square.

FIG. 8c shows a configuration implemented to be complementary or inverse to the configuration as depicted in FIG. 8b. The piezo sound transducer 12 is shaped to be quadrangular, or square, and is enclosed by the MUT sound transducer 22, which has the shape of the polygon track.

FIG. 8d shows a schematic perspective view of the configuration of FIG. 8a. A focus point (focus area) 67 of the MUT sound transducer 22 and a focus point (focus area) 69 of the piezo sound transducer 12 may be arranged along the line 21. The focus points 67 and/or 69 may relate to a respective natural focus exhibited by the MUT sound transducer 22 and/or the piezo sound transducer 12 when they are in an non-controlled state, or in a state not influenced by a control device. The natural focus may be shifted, e.g., via beam forming at the transmitting and/or receiving end. The line 71 may be, e.g., a midperpendicular of the piezo sound transducer 12 and/or of the MUT sound transducer 22, or may be a line parallel thereto. In simple terms, the transducer device 80 may be configured to transmit in one direction and to receive a sound wave from the same direction. Even though the points (areas) 67 and 69 are depicted to differ from one another, the points (areas) 67 and 69 may also be arranged at a same location.

Alternatively, the MUT sound transducer 22 depicted as an enclosing bar and/or the piezo sound transducer 12 may also be formed two-dimensionally. Centers of the sound transducers 12 and 22 may each have a position along at least one spatial direction x, y and z, said position differing from the position of the respectively other sound transducer.

Even though the sound transducers 12 and 22 are depicted to be circular or quadrangular, or square, any other shapes may be implemented. In addition, the sound transducers 12 and 22 may be shaped differently from one another. For example, the MUT sound transducer 22 may be circular and the piezo sound transducer 12 may have a polygonal shape, or vice versa. For example, a diameter of the MUT sound transducer 22 and/or a diagonal of the piezo sound transducer 12 of FIG. 8c may have any dimensions, e.g., within a range from at least 0.1 mm to 500 mm at the most, from at least 0.2 mm to 200 mm at the most, or from at least 0.5 mm to 100 mm at the most.

In other words, MUT and piezo transducers may be integrated adjacently within an ultrasonic transducer. In this context, arrays of any shapes may be feasible which are also able to include and enclose one another.

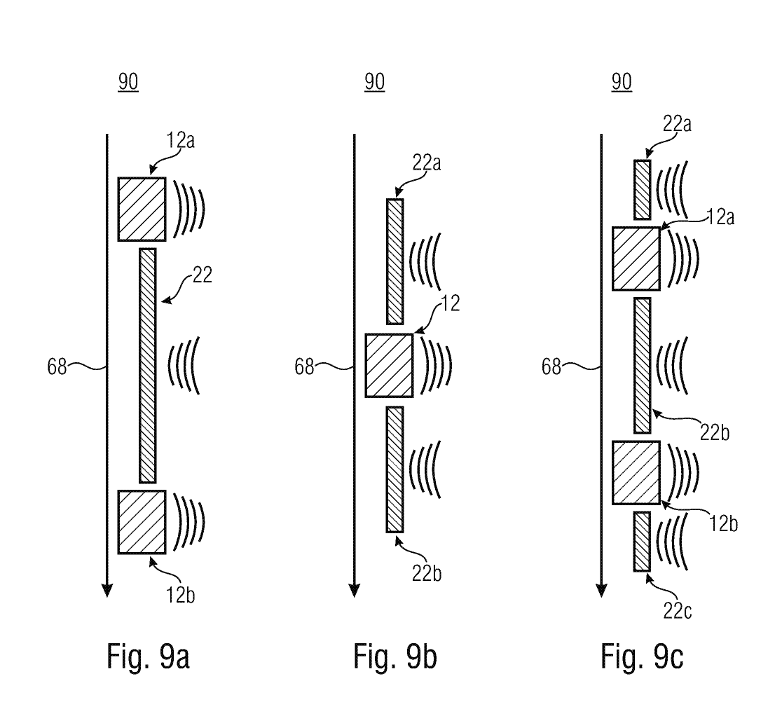

FIGS. 9a-c show schematic views of a transducer device 90 comprising a multitude of sound transducers. The transducer device 90 includes at least two piezo sound transducers and/or at least two MUT sound transducers. Two similar sound transducers (piezo sound transducers or MUT sound transducers) are spaced apart along a path 68 by a sound transducer of a different type (MUT sound transducer or piezo sound transducer, respectively).

According to the configuration depicted in FIG. 9a, two piezo sound transducers 12a and 12b are spaced apart along the path 68 by the MUT 22 sound transducer.

According to the configuration depicted in FIG. 9b, two MUT sound transducers 22a and 22b are spaced apart along the path 68 by the piezo sound transducer 12.

According to the configuration as depicted in FIG. 9c, two MUT sound transducers 22a and 22b, and 22b and 22c, respectively, are spaced apart along the path 68 by one piezo sound transducer 12a and 12b, respectively.

Even though the acoustic transducer device 90 is described to comprise at least two piezo sound transducers or at least two MUT sound transducers, in accordance with further embodiments, acoustic transducer devices may include more than two, more than five or more than ten piezo sound transducers and/or more than two, more than five or more than ten MUT sound transducers. The piezo sound transducers and the MUT sound transducers may be arranged to alternative (to interlace); it is also possible for two or more sound transducers of the same type to be arranged next to one another in places. At least one piezo sound transducer may be configured as a modified piezo sound transducer, as described in connection with FIG. 2. At least one MUT sound transducer may be configured as a modified MUT sound transducer, as described in connection with FIG. 3. One or more sound transducers may be arranged, e.g., at a shared substrate, e.g., a board or a silicon substrate, for example.

In other words, acoustic transducer devices may also include more than one MUT sound transducer or more than one piezo transducer. One or more transducers may be configured both as individual elements and as an array.

FIGS. 8a-c and 9a-c show offset arrangements of both types of transducers, FIGS. 8a-c showing enclosing configurations, and FIGS. 9a-c showing adjacently arranged configurations.

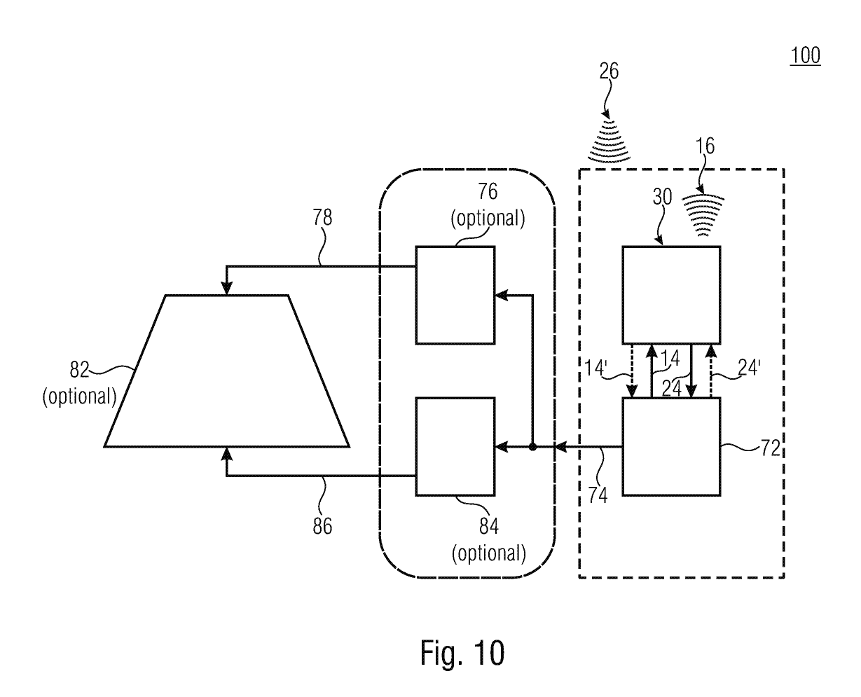

FIG. 10 shows a schematic block diagram of an acoustic system 100. The acoustic system 100 includes, e.g., the acoustic transducer device 30 and a control device 72. The control device 72 is configured to control the piezo sound transducer of the transducer device 30. For example, the control device 72 is configured to supply the control signal 14 to the transducer device 30.

The control device 72 is further configured to provide an information signal 74. The information signal may comprise information relating to obtaining the sound wave 26. The sound wave 26 may be obtained on the basis of a reflection of the sound wave 16 at an object. On the basis of the arrival of the sound wave 26, the transducer device 30 may be configured to supply the output signal 24 of the MUT sound transducer to the control device 72.

The acoustic system 100 may include a processing arrangement 75. The processing arrangement 75 may be configured to obtain the information signal 74 from the control device 72. The processing means 75 may include an optional processor 76 configured to perform said functionality. The processor 76, or the processing arrangement 75, may be configured to generate an image signal 78 from the information signal 74. The image signal 78 may be presentable as an optical image of the sound wave 26 received.

The acoustic system 100 may comprise an optional display element 82 configured to present the image signal 78. This may enable an imaging acoustic method, e.g., visualization of a sonogram.

As an alternative or in addition to the processor 76, the processing arrangement 75 may include an optional processor 84. The processing arrangement 75 may be configured to determine, on the basis of the information signal, information regarding the sound wave 16 and/or 26, e.g., on the basis of a functionality of the processor 84. For example, the information may be a direction from which the sound wave 26 is received by the transducer device 30. The processor 84 and/or the processing arrangement 75 may be configured to provide a processed information signal 86 which is based on the information signal 74. The processor 84, or the processing arrangement 75, may further be configured to supply the processed information signal 86 to the optional display element 82.

The optional display element 82 may be configured to display the information which has been determined by the optional processor 84. This may be effected graphically and/or in the form of text, for example. The optional display element 82 may be a display, a monitor, or an acoustic display, for example.

As an alternative or in addition to the acoustic transducer device 30, the acoustic system 100 may also include at least a different or further acoustic transducer device 10, 20, 30, 40, 50, 70, 80 and/or 90.

The acoustic transducer device may comprise at least one piezo sound transducer 12; the control device 72 may be configured to control the piezo sound transducer, or the piezo sound transducer elements, within a first time interval such that the sound wave 16 is emitted in a first direction, and may be configured to control the piezo sound transducer, or the piezo sound transducer elements, within a second time interval such that the sound wave 16 is emitted in a second direction, e.g., for implementing a beam forming function.

This enables variable radiation pattern of the acoustic transducer devices 30; mechanical components of the system moving to a small extent or not at all. This may be understood to mean that pivoting of a test head may be dispensed with or is performed to a small extent.

The control device 72 may be configured to control one or more of the piezo sound transducers such that they (and/or piezo sound transducer element thereof) move at a frequency which essentially corresponds to a mechanical resonant frequency of the MUT sound transducer. In simple terms, the control device 72 may be configured to control a piezo sound transducer 12 and/or 12′ at which an MUT sound transducer 22 and/or 22′ is fixedly arranged, as is described within the context of FIG. 1, 2, 3, 4 or 5, at a frequency which corresponds to a mechanical resonant frequency of the MUT sound transducer. The control device 72 may be configured to control the piezo sound transducer 12 and/or 12′ roughly in phase (resonance) or opposite in phase (anti-resonance). For example, a frequency within a tolerance range which lies within a range of smaller than or equal to ±10%, smaller than or equal to ±5%, or smaller than or equal to ±1%, of the mechanical resonant frequency of the MUT sound transducer 22 or 22′ may essentially correspond to the resonant frequency.

In the event of in-phase excitation this may enable radiation of the piezo sound transducer to be amplified by the MUT sound transducer caused to resonate. By operating the piezo sound transducer in anti-resonance with the (possibly non-controlled) MUT sound transducer, attenuation of the sound wave 16 may be obtained which results in an increase in the bandwidth of the sound wave 16. In simple terms, it is at the cost of the amplitude and/or of the sound pressure level of the sound wave 16 that a bandwidth with which said sound wave 16 is emitted may be increased. In the event of in-phase operation, the control device 72 may be configured to perform excitation of the piezo sound transducer such that resonant vibration of the MUT sound transducer and/or of its vibrating plate thereof is obtained, so that radiation is additionally amplified. The interaction of both transducers may also be exploited for mutual attenuation (anti-resonance). This may result in a larger bandwidth, for example.

The control device 72 may be configured to provide the information signal 74, alternatively or additionally, based on an output signal 14′, which may be obtained from the piezo sound transducer. The reciprocity of the piezo effect enables the piezo sound transducer 12 or 12′ to be influenced on the basis of the sound wave 26, so that a corresponding signal may be obtained at terminals of the piezo sound transducer. Said terminals may be the same terminals at which the signal 14 is provided.

Similarly, the control device 72 may be configured to co-excite the MUT sound transducer 22 and/or 22′ to emit the sound wave 16, for example in that the control device 22 is configured, for example, to provide the MUT sound transducer 22 and/or 22′ with a control signal 24′. The control signal 24′ may be in phase with the control signal 24. Alternatively, the control signal 24′ may also be offset in phase with regard to the control signal 24, i.e., be opposite in phase. This means that the control device 72 may be configured to simultaneously control the piezo sound transducer and the MUT sound transducer during a time interval, so that the piezo sound transducer and the MUT sound transducer generate the sound wave 16 at the same time.

The optional processor 76 and/or the optional processor 84 of the processing arrangement 75 may be configured, e.g., as integrated circuits, as field-programmable gate arrays (FPGAs) or as computer processors (CPUs) or as graphical processors (GPUs). Alternatively or additionally, the processors may also be configured, at least partly, as software. Moreover, the processors 76 and 84 may be configured as a shared processor.

Alternatively, both sound transducers (piezo sound transducer and MUT sound transducer) may be operated at different frequencies, so that in addition to the sound wave 16, a further sound wave is emitted. Reflections of both waves may be received by the acoustic transducer device 30 or by a different acoustic transducer device which is alternatively or additionally arranged. On this basis, the information signal may comprise information regarding two transmitted and/or received sound waves, so that two different ultrasonic transducers may be implemented within one system.

Transmission of the sound wave 16 or of a further sound wave by means of the MUT or an MUT array enables amplification of the sound wave 16 and/or adaptation of a resulting sound field of the piezo sound transducer. The MUT sound transducer may have a larger bandwidth of an emitted sound wave than a piezo sound transducer. For example, a piezo sound transducer may comprise a bandwidth ranging between 60% and 70% of the center frequency (of the frequency at which the piezo sound transducer is controlled). An MUT sound transducer may comprise a bandwidth ranging from 100% to 130% of the center frequency. A typical center frequency may range from 1 MHz to 100 MHz, from 10 MHz to 50 MHz, and/or from 20 MHz to 40 MHz. In principle, any frequencies may be set, i.e., a system may be configured to operate at any frequencies and may be implemented in accordance with a configuration. By generating sound waves in parallel by using piezo sound transducers and MUT sound transducers, it is possible to also exploit, in addition to the high efficiency of the piezo sound transducer, the typically larger bandwidth of the MUT sound transducer.

Control and/or readout electronics, such as the control device 72, may be arranged directly at the MUT sound transducer and/or be directly integrated in the acoustic transducer device or the acoustic transducer system. For example, the control device 72 may be configured as a CMOS (complementary metal oxide semiconductor). For example, an MUT-on-CMOS structure may thus be realized. This may result in that the electronics is exposed to the ultrasonic waves of the piezo sound transducer, for example when an acoustic transducer device in accordance with the explanations given in the context of FIG. 1, 2, 3, 4 or 5 is implemented. In other words, integrating the readout electronics on a CMOS basis directly at the transducer itself enables obtaining a high-quality or even ideal (ultra)sound receiver.

Mechanical and/or acoustic coupling of the piezo sound transducer and of the MUT sound transducer enable mutual calibration of the transducers employed. For example, actuation of the MUT sound transducer or of the piezo sound transducer may be sampled, i.e. sensed, by the respectively other sound transducer and be evaluated by means of the information signal 74. This enables adaptation of the signals 14, 14′, 24 and/or 24′ in order to obtain a desired behavior of the acoustic transducer device, or of the acoustic system.

Previously described embodiments describe combining of two independent transducer technologies as a system, as an acoustic transducer device. This differs from a configuration as a PMUT sound transducer seen individually. For example, embodiments may be implemented as a piezo sound transducer in combination with a PMUT sound transducer or as a combination of a piezo sound transducer and a CMUT sound transducer.

In other words, an idea of the present invention includes combining of micromachined ultrasonic transducers (MUTs) for receiving signals, and other transducer technologies (e.g. PZT ceramics) for transmitting signals.

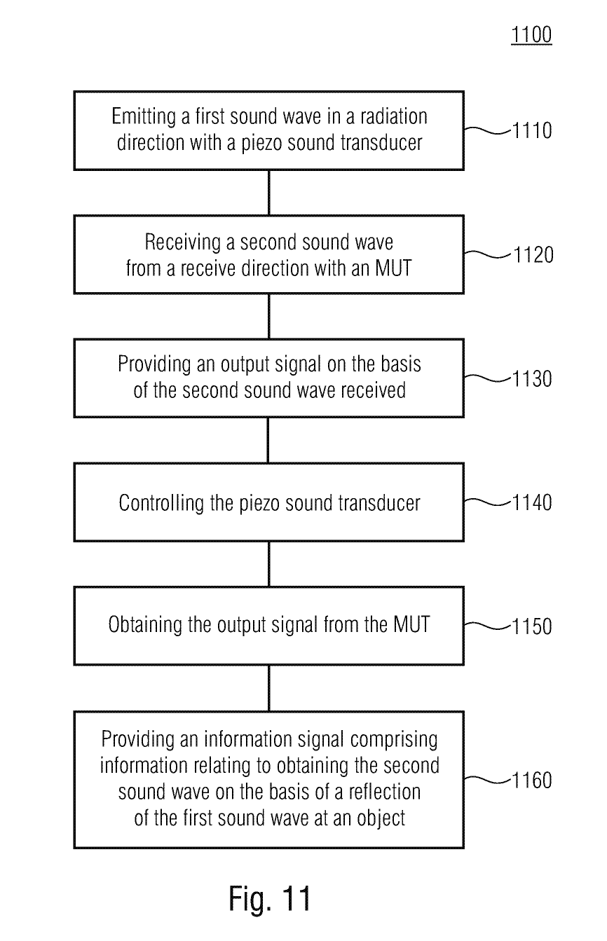

FIG. 11 shows a schematic flow chart of a method 1100 of operating an acoustic transducer structure, e.g. the acoustic transducer structure 10, 20, 30, 40, 50, 70, 80, or 90.

A step 1110 includes emitting a first sound wave in a radiation direction with a piezo sound transducer. A step 1120 includes receiving a second sound wave from a receive direction with an MUT sound transducer. A step 1130 includes providing an output signal on the basis of the received second sound wave.

An optional step 1140 includes controlling the piezo sound transducer. An optional step 1150 includes obtaining the output signal from the MUT sound transducer. An optional step 1160 includes providing an information signal comprising information relating to obtaining the second sound wave on the basis of a reflection of the first sound wave at an object. Steps 1140, 1150 and/or 1160 may be performed, e.g., when the acoustic transducer device is coupled to a control device.

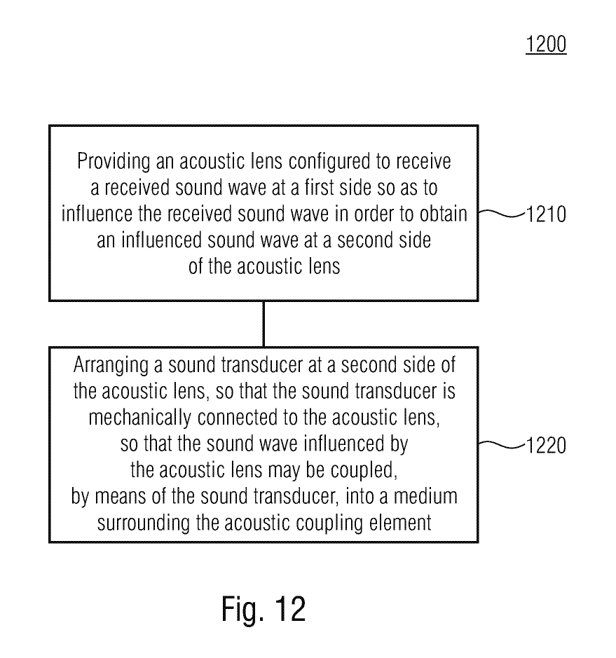

FIG. 12 shows a schematic flow chart of a method 1200 for producing an acoustic coupling element. The method 1200 includes a step 1210 wherein an acoustic lens is provided which is configured to receive a received sound wave at a first side so as to influence the received sound wave in order to obtain an influenced sound wave at a second side of the acoustic lens. A step 1220 includes arranging a sound transducer at a second side of the acoustic lens, so that the sound transducer is mechanically connected to the acoustic lens, so that the sound wave influenced by the acoustic lens may be coupled, by means of the sound transducer, into a medium surrounding the acoustic coupling element.

Even though some of the above explanations relate to arranging sound transducers, and even though some embodiments relate to arranging a plurality of sound transducer elements, said above explanations may be interchanged as desired. This means that embodiments comprising a piezo sound transducer 12 may alternatively or additionally include a piezo sound transducer 12′, and vice versa. Embodiments comprising an MUT 22 sound transducer may alternatively or additionally include an MUT sound transducer 22′, and vice versa.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or actually do cooperate, with a programmable computer system such that the respective method is performed. This is why the digital storage medium may be computer-readable. Therefore, some embodiments in accordance with the invention thus include a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer. The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer. A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### LITERATURE

[1] Schuster, Lach, Platte “Die Qual der Wahl: Welcher Prüfkopf für welchen Einsatz?, 2004. In DACH Tagung, Sonderdruck (offprint) SD 1/51 Salzburg
[2] Xiwei, H., Jia, H. C., Hyouk, K. C., Hongbin, Y., Minkyu, J., and Hao, Y., “A high-frequency transimpedance amplifier for CMOS integrated 2D CMUT array towards 3D ultrasound imaging,” 2013. In Engineering in Medicine and Biology Society (EMBC), 2013 35th Annual International Conference of the IEEE, 101-04.

1. An acoustic transducer device comprising:
a piezo sound transducer configured to emit a first sound wave in a radiation direction on the basis of a control signal; and
an MUT sound transducer configured to provide an output signal on the basis of a second sound wave received from a receive direction;
wherein the piezo sound transducer and the MUT sound transducer are arranged such that the MUT sound transducer encloses the piezo sound transducer when a location of the piezo sound transducer and a location of the MUT sound transducer are projected into a plane; and
wherein an internal dimension of the MUT sound transducer is larger than an external dimension of the piezo sound transducer.

2. The acoustic transducer device as claimed in claim 1, wherein the MUT sound transducer is arranged along the radiation direction of the piezo sound transducer.

3. The acoustic transducer device as claimed in claim 1, wherein the piezo sound transducer and the MUT sound transducer are acoustically coupled to each other, so that the MUT sound transducer is directly excited by emission of the first sound wave on the part of the piezo sound transducer.

4. The acoustic transducer device as claimed in claim 1, further comprising an acoustic coupling element configured to acoustically couple the piezo sound transducer and the MUT sound transducer.

5. The acoustic transducer device as claimed in claim 4, wherein the acoustic coupling element is an acoustic lens configured to influence propagation of the first sound wave, the MUT sound transducer being mechanically connected to the acoustic lens, so that the first sound wave emitted by the piezo sound transducer and influenced by the acoustic lens impinges on the MUT sound transducer and is coupled into a medium by the MUT sound transducer.

6. The acoustic transducer device as claimed in claim 1, wherein the piezo sound transducer and the MUT sound transducer are fixedly connected to each other within a stack, wherein moving of an element of the piezo sound transducer or of the MUT sound transducer may cause a movement in an element of the other sound transducer.

7. An acoustic transducer device comprising:
a piezo sound transducer configured to emit a first sound wave in a radiation direction on the basis of a control signal; and
an MUT sound transducer configured to provide an output signal on the basis of a second sound wave received from a receive direction; and
an acoustic coupling element configured to acoustically couple the piezo sound transducer and the MUT sound transducer;
wherein the acoustic coupling element is an acoustic lens configured to influence propagation of the first sound wave, the MUT sound transducer being mechanically connected to the acoustic lens, so that the first sound wave emitted by the piezo sound transducer and influenced by the acoustic lens impinges on the MUT sound transducer and is coupled into a medium by the MUT sound transducer.
wherein the piezo sound transducer and the MUT sound transducer are arranged such that the piezo sound transducer encloses the MUT sound transducer.

8. The acoustic transducer device as claimed in claims 1 and 7, comprising a multitude of sound transducers arranged along a path, said multitude of sound transducers comprising a plurality of piezo sound transducers or a plurality of MUT sound transducers, and the plurality of piezo sound transducers being spaced apart by the MUT sound transducer along the path and/or the plurality of MUT sound transducers being spaced apart by the piezo sound transducer along the path.

9. The acoustic transducer device as claimed in claims 1 and 7, wherein the piezo sound transducer and/or the MUT sound transducer is formed as an array comprising a plurality of sound transducer elements.

10. The acoustic transducer device as claimed in claim 8, wherein the plurality of sound transducer elements of a sound transducer are mechanically connected to one another.

11. The acoustic transducer device as claimed in claims 1 and 7, wherein the receive direction and the radiation direction are trigonometrically linked via an object reflecting the sound wave.

12. The acoustic transducer device as claimed in claims 1 and 7, wherein a directional component of the radiation direction and a directional component of the receive direction are identical.

13. An acoustic transducer device comprising:
a piezo sound transducer configured to emit a first sound wave in a radiation direction on the basis of a control signal; and
an MUT sound transducer configured to provide an output signal on the basis of a second sound wave received from a receive direction;
wherein the piezo sound transducer and the MUT sound transducer are acoustically coupled to each other, so that moving of an element of the piezo sound transducer may cause a movement in an element of the MUT sound transducer, and vice versa, so that by performing a movement on the part of the piezo sound transducer, said movement is transferred to the MUT sound transducer, and a movable element thereof is excited to move, oscillate or vibrate, so that the MUT sound transducer is directly excited by emission of the first sound wave on the part of the piezo sound transducer.

14. An acoustic transducer device comprising:
a piezo sound transducer configured to emit a first sound wave in a radiation direction on the basis of a control signal; and
an MUT sound transducer configured to provide an output signal on the basis of a second sound wave received from a receive direction;
wherein an internal dimension of the piezo sound transducer is larger than or equal to an external dimension of the MUT sound transducer; and
an acoustic coupling element configured to acoustically couple the piezo sound transducer and the MUT sound transducer.

15. An acoustic system comprising:
an acoustic transducer device as claimed in claims 1, 7 and 13;
a control device configured to control the piezo sound transducer of the transducer device so as to acquire the output signal from the MUT sound transducer and so as to provide an information signal comprising information which relates to acquiring the second sound wave on the basis of a reflection of the first sound wave at an object.

16. The acoustic system as claimed in claim 15, wherein the control device is configured to control the piezo sound transducer and the MUT sound transducer simultaneously during a time interval, so that the piezo sound transducer and the MUT sound transducer generate the first sound wave at the same time.

17. The acoustic system as claimed in claim 15, comprising a processing arrangement configured to acquire the information signal from the control device and to generate from the information signal an image signal which may be represented as an optical image of the received sound wave and is based on a reflection of the first sound wave at the object, so that the second sound wave is acquired.

18. The acoustic system as claimed in claim 15, wherein the transducer device comprises a multitude of MUT sound transducer elements, the information signal being based on a multitude of output signals which are based on the second sound wave, the acoustic system comprising a processing arrangement configured to determine, on the basis of the information signal, a direction from which the second sound wave is received by the transducer device.

19. The acoustic system as claimed in claim 15, further comprising a display element configured to present an image signal or information based on the information signal.

20. The acoustic system as claimed in claim 15, wherein the piezo sound transducer is formed as an array comprising a plurality of piezo sound transducer elements, the control device being configured to control the multitude of piezo sound transducer elements within a first time interval such that the first sound wave is emitted in a first direction, and to control the multitude of piezo sound transducer elements within a second time interval such that the first sound wave is emitted in a second direction.

21. The acoustic system as claimed in claim 15, wherein the piezo sound transducer and the MUT sound transducer of the transducer device are fixedly connected to each another within a stack, wherein moving of an element of the piezo sound transducer may cause a movement in at least one element of the MUT sound transducer, and wherein the control device is configured to control the piezo sound transducer such that it moves at a frequency within a tolerance range which lies within a range of smaller than or equal to ±10% of a mechanical resonant frequency of the MUT sound transducer.

22. An acoustic system comprising:
an acoustic transducer device comprising:
a piezo sound transducer configured to emit a first sound wave in a radiation direction on the basis of a control signal; and
an MUT sound transducer configured to provide an output signal on the basis of a second sound wave received from a receive direction;
wherein the piezo sound transducer and the MUT sound transducer are arranged such that the MUT sound transducer encloses the piezo sound transducer when a location of the piezo sound transducer and a location of the MUT sound transducer are projected into a plane;
a control device configured to control the piezo sound transducer of the transducer device so as to acquire the output signal from the MUT sound transducer and so as to provide an information signal comprising information which relates to acquiring the second sound wave on the basis of a reflection of the first sound wave at an object
wherein the transducer device comprises a multitude of MUT sound transducer elements, the information signal being based on a multitude of output signals which are based on the second sound wave, the acoustic system comprising a processing arrangement configured to determine, on the basis of the information signal, a direction from which the second sound wave is received by the transducer device.

23. An acoustic system comprising:
an acoustic transducer device comprising:
a piezo sound transducer configured to emit a first sound wave in a radiation direction on the basis of a control signal; and
an MUT sound transducer configured to provide an output signal on the basis of a second sound wave received from a receive direction;
wherein the piezo sound transducer and the MUT sound transducer are arranged such that the MUT sound transducer encloses the piezo sound transducer when a location of the piezo sound transducer and a location of the MUT sound transducer are projected into a plane;
a control device configured to control the piezo sound transducer of the transducer device so as to acquire the output signal from the MUT sound transducer and so as to provide an information signal comprising information which relates to acquiring the second sound wave on the basis of a reflection of the first sound wave at an object
wherein the piezo sound transducer and the MUT sound transducer of the transducer device are fixedly connected to each another within a stack, wherein moving of an element of the piezo sound transducer may cause a movement in at least one element of the MUT sound transducer, and wherein the control device is configured to control the piezo sound transducer such that it moves at a frequency within a tolerance range which lies within a range of smaller than or equal to ±10% of a mechanical resonant frequency of the MUT sound transducer.

24. An acoustic system comprising:
an acoustic transducer device comprising:
a piezo sound transducer configured to emit a first sound wave in a radiation direction on the basis of a control signal; and
an MUT sound transducer configured to provide an output signal on the basis of a second sound wave received from a receive direction;
a control device configured to control the piezo sound transducer of the transducer device so as to acquire the output signal from the MUT sound transducer and so as to provide an information signal comprising information which relates to acquiring the second sound wave on the basis of a reflection of the first sound wave at an object;
wherein the control device is configured to control the piezo sound transducer and the MUT sound transducer simultaneously during a time interval, so that the piezo sound transducer and the MUT sound transducer generate the first sound wave at the same time.

25. A method of operating an acoustic transducer structure comprising a piezo sound transducer, an MUT sound transducer, wherein an internal dimension of the MUT sound transducer is larger than an external dimension of the piezo sound transducer, the method comprising:
emitting a first sound wave in a radiation direction with a piezo sound transducer;
receiving a second sound wave from a receive direction with an MUT sound transducer, wherein the piezo sound transducer and the MUT sound transducer are arranged such that the MUT sound transducer encloses the piezo sound transducer when a location of the piezo sound transducer and a location of the MUT sound transducer are projected into a plane; and
providing an output signal on the basis of the received second sound wave.

26. The method as claimed in claim 25, wherein emission of the first sound wave is performed such that on the basis of the piezo sound transducer and the MUT sound transducer being acoustically coupled to each other, the MUT sound transducer is directly excited by emission of the first sound wave on the part of the piezo sound transducer.

27. A method of operating an acoustic transducer structure, comprising:
arranging a piezo sound transducer and an MUT sound transducer such that the piezo sound transducer encloses the MUT sound transducer;
providing an acoustic coupling element, so that the piezo sound transducer and the MUT sound transducer are acoustically coupled to each other;
wherein the acoustic coupling element is an acoustic lens and is provided such that propagation of the first sound wave is influenced, the MUT sound transducer being mechanically connected to the acoustic lens, so that the first sound wave emitted by the piezo sound transducer and influenced by the acoustic lens impinges on the MUT sound transducer and is coupled into a medium by the MUT sound transducer;
emitting a first sound wave in a radiation direction with a piezo sound transducer;
receiving a second sound wave from a receive direction with an MUT sound transducer; and
providing an output signal on the basis of the received second sound wave.

28. The method as claimed in claims 25 and 27, further comprising:
controlling the piezo sound transducer;
acquiring the output signal from the MUT sound transducer; and
providing an information signal comprising information relating to acquiring the second sound wave on the basis of a reflection of the first sound wave at an object.

29. A method of operating an acoustic transducer structure comprising a piezo sound transducer, an MUT sound transducer, wherein an internal dimension of the piezo sound transducer is larger than or equal to an external dimension of the MUT sound transducer, the method comprising:
emitting a first sound wave in a radiation direction with a piezo sound transducer;
receiving a second sound wave from a receive direction with an MUT sound transducer; and
providing an output signal on the basis of the received second sound wave;
providing an acoustic coupling element such that same is configured to acoustically couple the piezo sound transducer and the MUT sound transducer.
